(19) United States
(12) Patent Application Publication
(10) Pub. No.: US 2009/0223445 A1
(43) Pub. Date: Sep. 10, 2009

(54) Method for Attaching a Reinforcing Beam to the Floor Panel of a Car

(76) Inventors: Masanori Ogawa, Aichi (JP); Katsumi Terada, Aichi (JP); Junichi Hasegawa, Aichi (JP)

Correspondence Address: COOPER & DUNHAM, LLP, 30 Rockefeller Plaza, 20th Floor, NEW YORK, NY, 10112, US

(21) Appl. No.: 12/092,315

(22) PCT Filed: Oct. 12, 2006
(86) PCT No.: PCT/JP2006/320389

§ 371 Date: May 1, 2008

(30) Foreign Application Priority Data
Nov. 1, 2005 (JP) 2005-317832

(51) Int. Cl. B05B 15/04

(52) U.S. Cl. 118/504

(57) ABSTRACT

The object of the present invention is to attach a part firmly to a component. A part attaching seat 7 of the component to which the part is to be attached, and a plural number of stud bolts 4,4 are covered with a masking member 9. The masking member 9 consists of a panel shaped seat covering part 10 and a bolt covering part 11, and the seat covering part 10 covers the part attaching seat 7 and the bolt covering part 11 covers the stud bolts 4,4 to protect the part attaching seat 7 and the stud bolts 4,4 from coating.

### FIELD OF THE INVENTION

The present invention relates to a masking member to protect a prescribed place from coating.

### BACKGROUND OF THE INVENTION

For example, a rust-proofing paint is coated on the underside of the floor panel of a car by spray coating. On the underside of said car floor panel, a pair of ribs 2, 2 are formed lengthwise at the left and right sides for reinforcing, with a reinforcing beam 3 being attached between said ribs 2,2 for additional reinforcement as shown in FIG. 1.

To attach said reinforcing beam 3 between said ribs 2,2, a pair of stud bolts 4,4 are each welded to said ribs 2,2 of said floor panel 1, said stud bolts 4,4 being respectively inserted into the bolts holes 5,5 formed on either side of said reinforcing beam 3, a pair of nuts 6,6 being screwed on to each of said stud bolts 4,4 from the underside of said reinforcing beam 3 as shown in FIG. 2.

Commonly, the coating of the underside of the car floor panel is carried out before said reinforcing beam 3 is attached between said ribs 2, 2, so that in a case where said coating reaches the reinforcing beam attaching location (attaching seat 7, stud bolt 4), the strength of the attachment of said reinforcing beam 3 is degraded by the coating film.

Therefore, up to now, masking tapes 8 have been attached to said attaching seat 7, to which said reinforcing beam 3 is to be attached, and to said stud bolt 4, following which coating is carried out.

### DISCLOSURE OF THE INVENTION

### The Problems to be Solved

It may be very troublesome to attach and remove said masking tapes 8 to/from said attaching seat 7, to which said reinforcing beam 3 is to be attached, and to/from said stud bolt 4, and such very troublesome operation may be a big impediment to a continuous mass production process such as that of a car.

### Means to Solve said Problems

As the means to solve said problem, the present invention provides a masking member 9 for protecting a part attaching seat 7 on the surface of a component 1 from coating by covering said part-attaching seat 7 with said masking member 9, wherein a plural number of stud bolts 4,4 are erected on said part attaching seat 7, said masking member 9 consisting of a panel shaped seat covering part 10 to cover said part attaching seat 7, and a bolt covering part 11 to cover a plural number of said stud bolts 4,4 at once, said bolt covering part 11 being recessed from said seat covering part 10.

Said masking member 9 of the present invention is applied advantageously to such as the coating process of the underside of a car floor panel. Said masking member 9 may be desirably made of a foamed plastic, and desirably a plural number of said masking members 9 are connected together through said seat covering part 10, with a snapping groove 12 being formed on the boundary between said masking members 9 adjoining each other.

### Effect of the Invention

### [Action]

Said masking member 9 of the present invention is attached to said part attaching location on the surface of a component 1, covering a plural number of said stud bolts 4, 4 at once with said bolt covering part 11, and covering said part attaching seat 7 with said seat covering part 10. After said masking member 9 has been attached to said part attaching location, coating is carried out on the surface of said component 1. After coating, said masking member 9 is removed from said part attaching location. Since said part attaching seat 7 and said stud bolts 4,4 are protected with said masking member 9, said coating does not reach either said part attaching seat 7 or said stud bolts 4,4. In a case where said masking member 9 is made of a foamed plastic, and a plural number of said masking members 9 are connected together through said seat covering part 10, with a snapping groove 12 being formed on the boundary between said masking members 9 adjoining each other, said masking member 9 is easily snapped at said snapping groove 12, the operation of attaching said masking member 9 being effectively carried out.

### [Effect]

In the present invention, said masking member is easily and efficiently attached to and removed from said part attaching location, to avoid the part attaching strength being degraded by the coating film, so that the present invention is especially useful for the continuous production process of a car, and the like.

### The Preferred Embodiment to Practice the Invention

An embodiment of the present invention is shown in FIGS. 1 to 7, and the masking member 9 of the present invention is shown in FIGS. 3 and 4. Said masking member 9 is used to protect the part attaching location of the pair of ribs 2,2 on the underside of the floor panel 1 of a car to which either side of a reinforcing beam 3 is to be attached as shown in FIGS. 1 and 2, and said masking member 9 consists of a panel shaped seat covering part 10 to cover said attaching seat 7 to which said reinforcing beam 3 is to be attached, and a bolt covering part 11 being recessed from said seat covering part 10, with a plural number of said masking members 9 being connected together through said seat covering part 10, and with a snapping groove 12 being formed on the boundary between said masking members 9 adjoining each other.

Said masking member 9 is made of a foamed thermoplastic such as polystyrene, polyethylene, polypropylene or the like, and in a case where said masking member 9 is made of foamed polystyrene, each masking member 9 is easily snapped from said groove 12. Said masking member 9 made of a foamed thermoplastic is manufactured by such as the foaming process wherein expandable thermoplastic beads are used.

Further, said masking member 9 may be manufactured by the vacuum and/or pressure molding of a non-foamed thermoplastic sheet. Said thermoplastics include, for example, polyethylene, polypropylene, ethylene-propylene copolymer, ethylene-propylene terpolymer, ethylene-vinyl acetate copolymer, poly(vinyl chloride), poly(vinylidene chloride), poly(vinyl acetate), fluororesin, thermoplastic polyester, thermoplastic polyamide, thermoplastic urethane resin, or the like.

Into said thermoplastic foam or non-foamed thermoplastic sheet, inorganic fillers such as calcium carbonate, magnesium carbonate, barium sulphate, calcium sulphate, calcium sulphite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, mica, calcium silicate, bentonite, white carbon, carbon black, iron powder, aluminium powder, stone powder, blast furnace slag, fly ash, cement, zirconia powder, or the like; natural fibers such as cotton, hemp, bamboo fiber, palm fiber, wool, silk, or the like; organic synthetic fibers such as polyamide fiber, polyester fiber, acrylic fiber, viscose fiber, acetate fiber, vinyl chloride fiber, vinylidene chloride fiber, vinylon fiber, or the like; inorganic fibers such as asbestos, glass fiber, carbon fiber, ceramic fiber, metal fiber, whisker, or the like; organic fillers such as, linter, linen, sisal, wood flour, coconut shell flour, walnut powder, starch, wheat flour, or the like; pigments; dyes; plasticizers such as dibutyl phthalate(DBP), dioctyl phthalate(DOP), or the like; antioxidants; antistatic agents; crystallizers; fire retardants; flameproof agents; insecticides; preservatives; wax; lubricants; antioxidants; ultraviolet absorbers, can be added.

Further, a laminated sheet of a foamed thermoplastic sheet and a non-foamed thermoplastic sheet may be used as the material for said masking member of the present invention.

Further, the material for said masking member of the present invention includes synthetic rubber such as acryl rubber, butyl rubber, silicone rubber, urethane rubber, fluororubber, polysulfide rubber, graft rubber, butadiene rubber, polybutadiene, isoprene rubber, polyisoprene, chloroprene rubber, polyisobutylene rubber, polybutene rubber, thiokol rubber, polysulfide rubber, polyether rubber, epichlorohydrin rubber, norbornene terpolymer, hydroxyl- or carboxy- end-group denatured polybutadiene, partially hydrogenated butadiene-styrene copolymer, chlorosulfonated rubber, isobutene -isoprene rubber, acrylate-butadiene rubber, butadiene-styrene rubber, acrylonitrile-butadiene rubber, butadiene-pyridine rubber, isoprene-styrene rubber, ethylene-styrene copolymer, polystyrene-polybutadiene-polystyrene, polystyrene-polyisoprene-polystyrene, poly(α-methylstyrene)-polybutadiene-poly(α-methylstyrene), poly(α-methylstyrene)-polyisoprene-poly(α-methylstyrene), butadiene-styrene copolymer, ethylene-propylene-ethylidene copolymer, ethylene-propylene-diene copolymer, ethylene-propylene copolymer rubber, ethylene-(1-butene) copolymer rubber, ethylene-propylene-ethylidenenorbornene copolymer rubber, ethylene-propylene- dicyclopentadiene copolymer rubber, ethylene-propylene-(1,4-hexadiene) copolymer rubber, ethylene-(1-butene)-ethylidenenorbornene copolymer rubber, ethylene-(1-butene)-dicyclopentadiene copolymer rubber, ethylene-(1-butene)-(1,4-hexadiene) copolymer rubber, acrylonitrile-chloroprene rubber, chloroprene -styrene rubber, or the like; natural rubber; a styrene group thermoplastic elastomer such as styrene-butadiene-styrene copolymer, styrene-isoprene-styrene copolymer, styrene-(hydrogenated polyolefin)-styrene copolymer, or the like; a block copolymer such as butadiene-styrene block copolymer, styrene-(intermediate block rubber)-styrene block copolymer, or the like; an engineering plastic such as polyamide, polyester, polyoxymethylene, poly(ethylene telephthalate), poly(buthylene telephthalate), polyphenylene sulfide, poly(ether ether ketone), methylpentene copolymer, poly(cyclohexane dimethyl terephthalate), or the like; and a polymer alloy including said engineering plastic and another thermoplastic resin. Said filler, additive, or the like may be added to said material.

Each masking member 9 is snapped at the snapping groove 12, and for example, said masking member 9 is attached to the part attaching location (part attaching seat 7) of said rib 2 on said floor panel 1 of a car as a component as shown in FIGS.5 and 6, a reinforcing beam 3 being attached to said part attaching seat 7. In this case, said bolt covering part 11 of said masking member 9 covers both stud bolts 4,4 at once, and said panel shaped covering part 10 covers said part attaching location 7.

In this situation, coating P is carried out on the underside of said floor panel, after which said masking member 9 is removed from said part attaching location. Since said part attaching location to which said reinforcing beam 3 is to be attached has been protected by said masking member 9 during coating, said part attaching seat 7 and said stud bolt 4 are not coated. Accordingly, either side of said reinforcing beam 3 can be firmly attached to said part attaching location of said ribs 2,2 as shown FIGS. 1 and 2.

Besides above described embodiment, the component in the present invention, of course, may include such as a cabinet, frame, and the like, and the part in the present invention, of course, may include a container, handle, and the like, each of which is attached to said cabinet, frame, and the like. Further, three or more stud bolts may be attached to said part attaching location. Still further, each masking member may be provided individually, other than as a connected plural number of masking members.

### Possibility of Industrial Use

Said masking member of the present invention can be easily attached to and removed from said part attaching location, and since coating does not reach said part attaching location, which is protected with said masking member during the coating process, said part attaching location is not covered with coating film, and said part can be firmly attached to said component.

Accordingly, the present invention is advantageously applied in the mass continuous production process of such as a car.

### BRIEF DESCRIPTION OF THE DRAWINGS

FIGS. 1 to 7 show an example of the present invention.

FIG. 1: Partial perspective view, describing the underside of a car floor.

FIG. 2: Perspective view, describing the location of the attaching of the reinforcing beam.

FIG. 3: Perspective view of the masking member.

FIG. 4: Sectional side view of the masking member.

FIG. 5. Perspective view, describing the situation of the attaching of the masking member.

FIG. 6: Side view, describing the situation of the attaching of the masking member.

FIG. 7: Perspective view, describing the situation after the masking member has been removed.

FIG. 8: Perspective view, describing a conventional example.

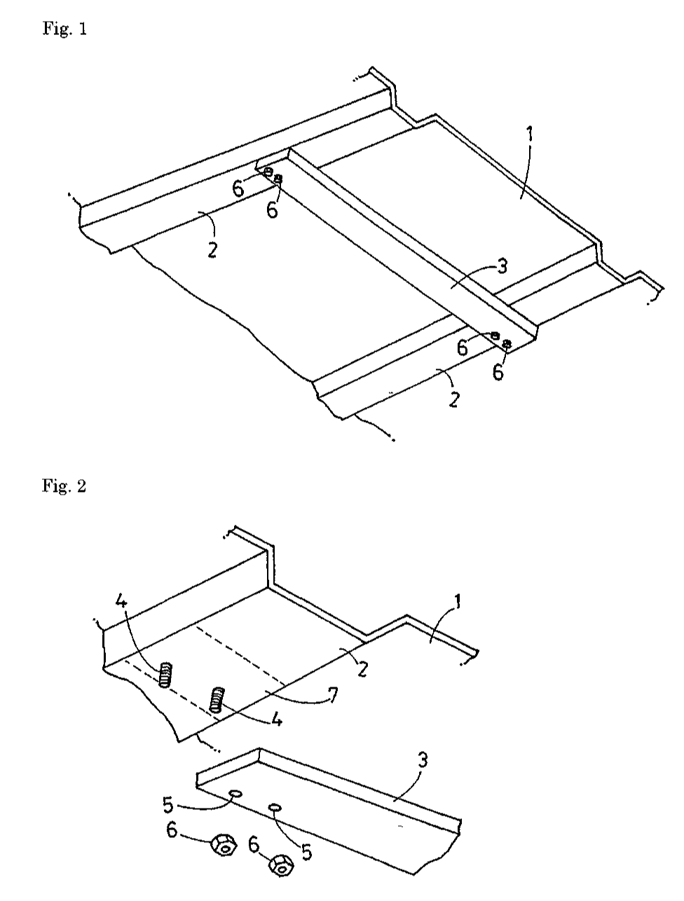

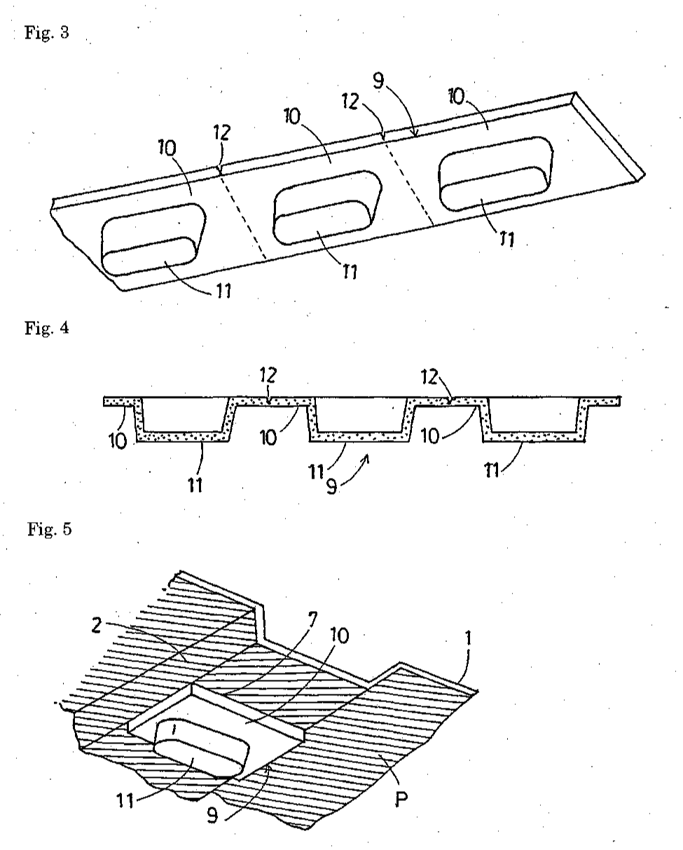

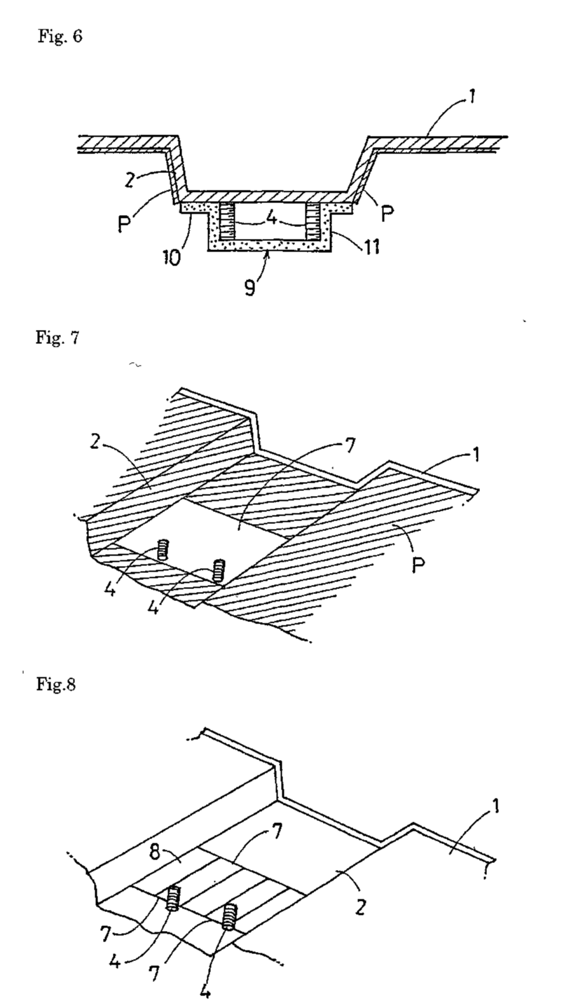

### DESCRIPTION OF NUMBERS

1: Component (floor panel of a car)
2: Rib
3: Reinforcing beam (part)
4: Stud bolt
7: Attaching seat
9: Masking member
10: Seat covering part
11: Bolt covering part
12: Snapping groove

1. A method for attaching a reinforcing beam to the floor panel of a cal; comprising; erecting a plural number of stud bolts at the part attaching seat of a pair of ribs which are formed lengthwise at the left and the right sides of the underside of the floor panel of a car, attaching a masking member to said part attaching location, said masking member consisting of a panel shaped seat covering part to cover said part attaching seat, and a bolt covering part to cover a plural number of said stud bolts at once, said bolt covering part being recessed from said seat covering part, thus said part attaching seat being covered with said seat covering part and said stud bolts being covered with said bolt covering part, coating the underside of said floor panel, removing said masking member from said part attaching location after coating, placing a reinforcing beam between said pair of right and left ribs, inserting each stud bolt into each bolt hole formed on either side of said reinforcing beam, and screwing nuts respectively onto said stud bolts from the underside of said reinforcing beam.

2. (canceled)

3. A method for attaching a reinforcing beam to the floor panel of a car in accordance with claim 1, wherein said masking member is made of a foamed plastic, and a plural number of said masking members are connected together through said seat covering part, with a snapping groove being formed on the boundary between said masking members adjoining each other.
